(19) United States
(12) Patent Application Publication
(10) Pub. No.: US 2002/0129351 A1
(43) Pub. Date: Sep. 12, 2002

(54) Software engine and method for software application loading

(75) Inventors: Thierry Bedos, Singapore (SG); Kwok Leong Hui, Singapore (SG)

Correspondence Address: MERCHANT & GOULD PC, P.O. BOX 2903, MINNEAPOLIS, MN, 55402-0903, US

(73) Assignee: NEXUSEDGE TECHNOLOGIES PTY. LTD.

(21) Appl. No.: 09/801,150

(22) Filed: Mar. 7, 2001

(51) Int. Cl. G06F 9/445

(52) U.S. Cl. 717/174; 717/175; 717/176

(57) ABSTRACT

A software engine application for loading onto a user's machine, wherein a core service of the application is loaded onto the user's machine to enable the application to commence to operate on the user's machine, the engine loading non-core services of the application according to a priority order determined by the engine. A corresponding method and a memory management system are also disclosed.

### FIELD OF THE INVENTION

This invention relates to a software engine and method for software application loading and refers particularly, though not exclusively, to a downloadable software engine and method for software application downloading. The invention has particular application for software applications written in Java, but is not to be restricted to applications in that language and is applicable to software applications written in other languages.

### BACKGROUND TO THE INVENTION

A software application such as, for example, an application in Java can be loaded onto a user's machine by, for example, being downloaded over the Internet. Present technology requires the entire application to be downloaded before use of the application can commence. This may be a Java Applet, or a stand-alone application. What is downloaded is the set of classes, in Java byte code, needed to execute the application. If the application is complex, a large number of classes may be required to be downloaded, thus implying a large amount of code to be downloaded. Part of the code is required for the application to start. However, some classes may not be used to start the application but will be used only after some time, after the user interacts with the application, or may not be used at all. As they have been downloaded at the beginning, they have increased the download time, and memory use. This is undesirable.

The nearest proposal has been that in Java World, Tips'N Tricks, Tip 95 available at http://www.javaworld.com/javaworld/javatips/jw-javatips95.html. However, this is a dynamic loading system from a user's machine that must be separately actioned for each application, not an engine in the application that will automatically activate itself.

It is therefore the principal object of the present invention to provide an engine to enable an application to be loaded progressively.

A further object is to provide such an engine where the initial loading is that part of the application that is required for the application to commence.

Another object is to provide such an engine where the remainder of the application is loaded is a controlled manner.

A final object is to provide a memory management system to improve application performance.

### SUMMARY OF THE INVENTION

With the above and other objects in mind, the present invention provides a software engine for software application loading onto a user's machine, wherein a core service of the application is loaded onto the user's machine to enable the application to commence to operate on the user's machine. The engine subsequently loads non-core services of the application according to a priority order determined by the engine. The engine may be part of, and is preferably loaded with, the core service; and may be started by the loading of the core service. Preferably, it starts upon completion of the loading of the core service.

The priority order may include a top priority, top priority being given to any non-core service of the application required to be on the user's machine as a result of interaction with the application by the user. The non-core services are preferably loaded in a manner controlled by the engine. The control may be exercised by the engine taking into account interaction with the application by the user.

Preferably, before loading the non-core services they are registered with the engine. More preferably, the engine checks the registration list of non-core services before loading a requested non-core service. The engine may be part of the application.

There may be provided a cache into which at least one object for the application can be stored. The cache may be operative only when the application is on the user's machine, and may include an object repository into which the at least one object is placed, and at least one object description. The object description may include one or more selected from the group consisting of: object reference, object key, reference counter and time stamp. The loading may be downloading, including downloading over the Internet.

Preferably, there is also provided a memory management module that keeps track of usage of cached objects; the memory management module being able to de-allocate one or more of the objects. The de-allocation of one or more of the objects may include an arbitrary time offset. If the object description of an object repository has a reference counter equal to zero for a time at least equal to the time offset, the corresponding object description may be removed from the object repository.

The engine may incorporate the memory management module if desired. Alternatively, the two may be independent of each other.

In another form, the present invention provides a method of loading a software application onto a user's machine using a software engine, the method including loading onto the user's machine core services of the application to enable the user to interact with the application, and loading the non-core services of the application according to a priority order determined by the engine.

Preferably, before loading the non-core services they are registered with the engine. The priority order may include a top priority, top priority being given to any non-core services of the application required to be on the user's machine as a result of interaction with the application by the user. Preferably, the loading of the non-core services is in a controlled manner controlled by the engine, the engine taking into account interaction with the application by the user.

Advantageously, the engine creates a registration list of non-core services prior to loading them, and may check the registration list of non-core services before loading a requested non-core service.

The loading may be a download, and may be over the Internet. Preferably, there is a cache into which at least one object for the application can be stored. More preferably, the cache is operative only when the application is on the user's machine.

The cache may include an object repository into which the object is placed, and an object description. The object description may include one or more of: object reference, object key, reference counter and time stamp.

The usage of cached objects may be tracked by a memory management module, which may de-allocate one or more of the objects, including by use of an arbitrary time offset. If the object description of an object repository has a reference counter equal to zero for a time at least equal to the time offset, the corresponding object description may be removed from the object repository. De-allocation may occur when the module notifies a cache operating system that a particular object is no longer required. The operating system can then delete the object from the cache, thus freeing memory. The freed memory can then be used when and as is required.

### DESCRIPTION OF THE DRAWINGS

In order that the invention may be readily understood and put into practical effect, a preferred embodiment of the present invention will now be described by way or non-limitative example only, the description being with reference to the accompanying illustrative drawings in which:

FIG. 1 is a representation of the system architecture;

FIG. 2 is a representation of the download engine;

FIG. 3 is a representation of the download engine after the first service download;

FIG. 4 is a representation of the download engine showing a change in the order of download;

FIG. 5 is a representation of the downloading engine at the end of the download process;

FIG. 6 is a representation of an object repository with an object list containing two object descriptions; and

FIG. 7 to 9 are representations of the operations of the memory management module.

### DESCRIPTION OF PREFERRED EMBODIMENT

The embodiment described provides a software engine or framework for progressively downloading a software application, and a memory management module for memory managing. This enables a large application to be downloaded and grow in several steps, while managing the amount of memory that is used on the client machine. A first set of core classes is downloaded on the client machine, and the rest of the application classes are downloaded by a background task on the client machine. If some classes are needed by the application due to a specific user interaction, the corresponding classes are downloaded with high priority. This engine/framework thus implements engine background loading as well as “on demand” loading. The memory management functionality frees some of the memory that the user does not use directly in order to reduce the amount of memory resources that the application uses on the client machine.

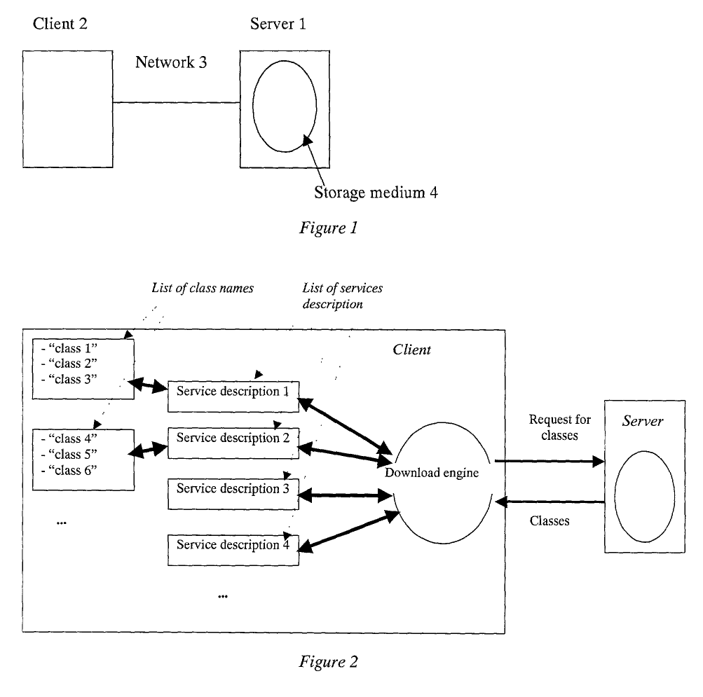

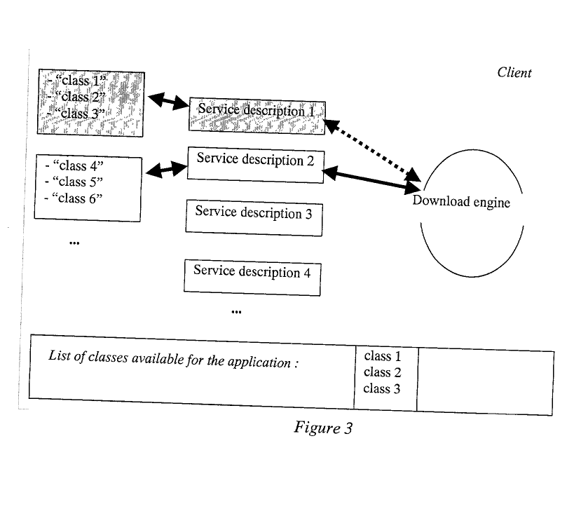

To first refer to FIG. 1, given a server machine 1 and a client machine 2 connected by a network 3, and a Java application such as, for example, a Java application to be downloaded from server 1 and executed on client machine 2, the present invention divides the application into a core application and additional services. The core application is all the application components (Java classes) that need to be downloaded for the application to start. The additional services are the sets of necessary components to be downloaded in order to execute subsequent functionality of the application. One service is equivalent to a functionality of the application. The engine may be part of the core application and is preferably loaded with the core application, and is triggered to start by the completion of the loading of the core application.

In the case of a graphical application, the core application is the main screen and the underlying objects needed to present this first screen to the user. The additional services consist of all the sub-screens of the application, the underlying services delivered by the application, and all results of interaction by the user with the application. Each service is described by the name of the one or more Java classes that are necessary to fulfill the service. Furthermore, the application establishes a link between all possible user interactions, and the corresponding service it triggers. Example, in case of a graphical application, the application maintains a relationship between a click on a button and the corresponding service to be started.

The loading engine or framework is a client task that is able to download Java classes from the server. It keeps a list of services to download, and downloads the classes needed for each service. This may be as simple as downloading the classes according to their order of appearance in the list. The order of downloading of classes can be changed. This will be instigated by the engine and may be due to, for example, user interaction, for more efficient use of the machine's resources, or to enable application classes already downloaded to be able to use the new classes to expand the operation of the application. It is able to add new services in its list of services. The download engine is part of the core application and is loaded with it. The completion of the loading of the core application, including the engine, triggers the engine to start. However, it may be started earlier, if desired. The engine is started by the operation of the core application, not the user. The link between the download engine and the server may be encrypted, if desired.

The download of the core application is initiated by the client 2 downloading and executing the Java byte code from server 1. The core application then requests from the server the description information for the additional services. The server gets this information from its storage medium 4 and sends it to the client 2. This step is not necessary if the services information is already contained in the core application classes.

The download engine is then started. The core application registers the services to be downloaded with the download engine, which starts downloading the necessary classes. The download may be in any order determined by the engine, including the registration order.

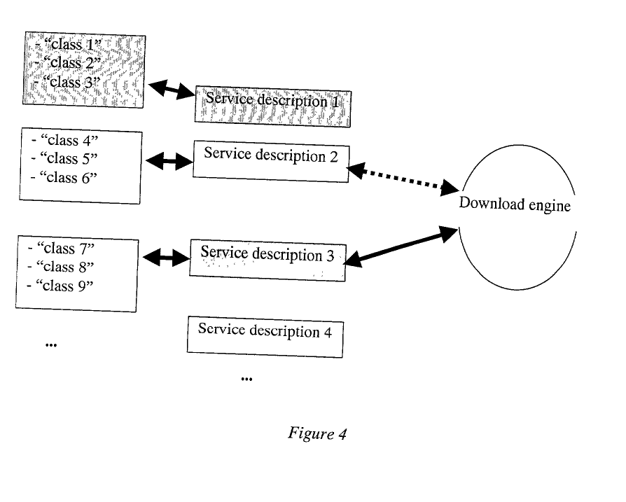

When the user interacts with the core application, certain additional services may need to be downloaded. In that case, the core application notifies the download engine that a specific service is required to be downloaded. The download engine checks if the corresponding service has already been downloaded. If not, it downloads the classes for this service as a matter of priority, and in any event before any other class. The code corresponding to the service is therefore downloaded and the application launches the service. As shown in FIG. 4, if service 3 needs to be downloaded due to a user interaction and service 2 is being downloaded but is not required at the time, the service 2 download is interrupted and service 3 is downloaded.

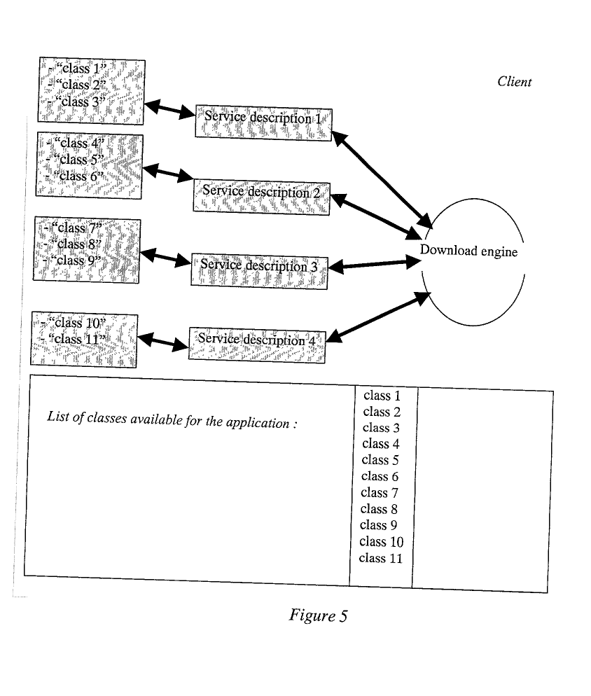

The download engine downloads all services in a controlled manner which may be either by the method described above, that which follows (see FIG. 5), or otherwise as required. Once the core application and all the registered non-core services have been downloaded, no more services may need to be downloaded as the user may not have interacted with the application. The engine therefore stands by and waits for further non-core services to be registered. At all times it is the engine that controls the loading order or priority. At any time, the application can request the download of a new service with the engine and have the engine download the additional code.

At the end of the operation, the application has “grown” because the amount of services/functionality available to the user is higher than at the launch of the application.

After the application is started on the client machine, being either the core application or the core application plus some services, the user starts to interact with it, and this causes the service engine to request services to be fulfilled by the application. Each service requires objects to be created in the memory of the users' machine. Such objects may include an image, a data structure, or a Java object that delivers a specific service, or otherwise. Once the service is complete, the Java virtual machine's garbage collector frees the memory used by the object.

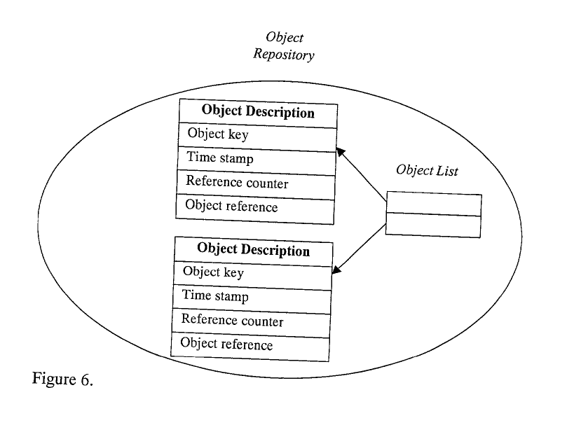

To refer to FIGS. 6 to 9, the system provides a process to cache such objects to allow for the application to subsequently re-use them without having to re-create them. This system, named object repository, increases performance when the user regularly requests the same service. The speed of the application is increased because the application does not need to re-create the object in memory. For example, in the case of a graphical application, the user may be prompted to answer a question. The application then displays a question box with the text of the question, and an icon in the shape of a question mark. The icon is represented by a Java object, which can be cached in memory. After the user has answered the question, and the question message box has been deleted, if the application needs to prompt the user with a new question, it can re-use the same icon object instead of re-creating it.

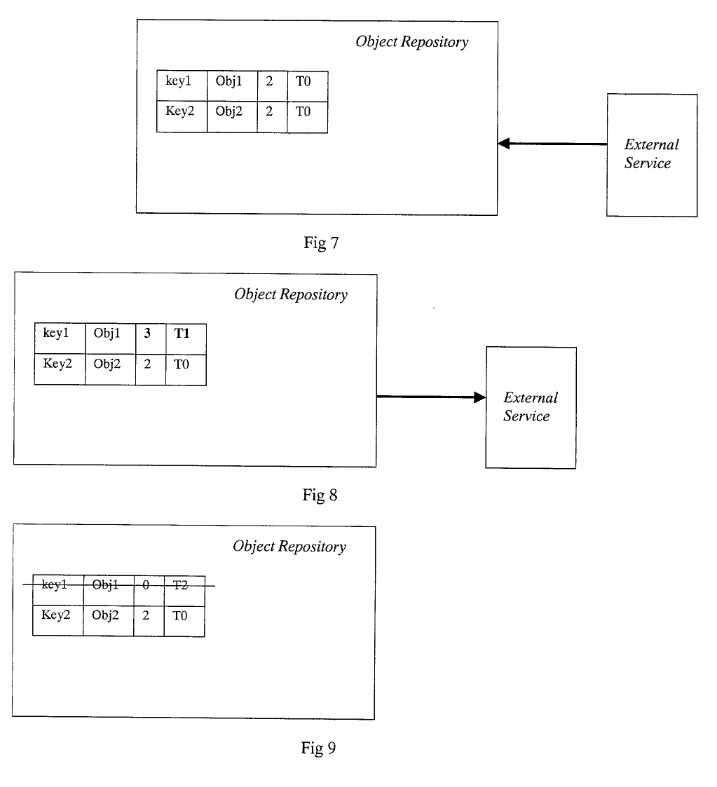

In order to be cached by the object repository, an object needs to be identified by a unique key (an instance of a valid Java class) such as “key1” or “key2” in FIGS. 7 to 9. In case of an image, it can be the name of the image, represented as a Java String.

An object description is a data structure that may contain at least the following information:

object reference—a Java reference to the object;

object key—the key associated with the object;

reference counter—the number of services currently using the object ( except the object repository); and

time stamp—the last time/date value for the invoking of the object in the object repository.

The object references is shown as “Obj1” and “Obj2” in FIGS. 7 to 9, the reference counter is shown in the third column of the tables of FIGS. 7 to 9; and the time stamp in the fourth column.

The object repository is a central repository for objects that are cached by the system in order to be re-used by various services. The object repository keeps track of the object descriptions in a data structure that persists as long as the application is running. This data structure is referred to as an object list. The object repository is able to:

add a new object description to the object list. This operation increases the reference counter of this object description and updates its time stamp;

remove an existing object description from the object list; and

find an object description based on a key, and return the corresponding object reference contained in the object description. This operation increases the reference counter of this object description, and updates its time stamp.

When a service requires a specific object, it first constructs a unique key corresponding to the object, then requests the object from the object repository based on the unique key of the object (FIG. 7). In FIG. 7, the request for Obj1 is by reference to key1. If the object is found in the object repository object list, it is returned to the service that made the request (FIG. 8).

If the object is not found in the object repository two possibilities arise, depending on the chosen implementation:

the object repository is able to create the object based on the key. The object repository creates the object and the object description, adds the object description to its object list and returns the object reference to the service which made the request;; or

the object repository is unable to create the object. It returns a “null” value to the calling service. The calling service will then have to create the object and add it to the object repository.

As shown in FIG. 9, when a service determines that it no longer needs to use the object (for example, for an image contained in a question dialog box, after the user has answered the question), it calls the object repository to decrease the reference counter for the object. This is because the memory occupied by the objects may increase dramatically thereby using the client's machine resources. The memory management module may therefore de-allocate some of the objects. For instance, an arbitrary time offset can be chosen by the application and, if an object description of the object repository has a reference counter equal to zero for a period of time greater or equal to the time offset, the corresponding object description is removed from the object repository. The Java virtual machine's garbage collector then clears the object from the memory of the client's machine

This memory management module frees the resources used by the application to enable application to execute at a higher level of performance, and without occupying an excessive amount of the resources of the client machine.

Whilst there has been described in the foregoing description a preferred embodiment of the present invention, it will be understood by those skilled in the technology that many variation or modifications may be made without departing from the present invention.

1. A software engine for application loading a software application onto a user's machine, wherein a core service of the application is loaded onto the user's machine to enable the application to commence to operate on the user's machine, the engine subsequently loading non-core services of the application according to a priority order determined by the engine.

2. A software engine as claimed in claim 1, wherein the engine is part of the core service and is loaded with the core service.

3. A software engine as claimed in claim 2, wherein the engine commences operation upon completion of loading of the core service.

4. A software engine as claimed in claim 1, wherein the priority order includes a top priority, top priority being given to any non-core service of the application required to be on the user's machine as a result of interaction with the application by the user.

5. A software engine as claimed in claim 1, wherein the non-core services are loaded in a manner controlled by the engine.

6. A software engine as claimed in claim 5, wherein the control takes into account user interaction with the application.

7. An engine as claimed in claim 5, wherein before loading the non-core services they are registered with the engine.

8. A software engine as claimed in claim 7, wherein the engine checks the registration list of non-core services before loading a requested non-core service.

9. A software engine as claimed in claim 1, wherein there is provided a cache into which at least one object for the application can be stored.

10. A software engine as claimed in claim 9, wherein the engine includes a memory management module that keeps track of usage of cached objects; the memory management module being able to de-allocate one or more of the objects.

11. A software engine as claimed in claim 10, wherein the cache is operative only when the application is on the user's machine.

12. A software engine as claimed in claim 9, wherein the cache includes an object repository into which the at least one object is placed, and an object description.

13. A software engine as claimed in claim 12, wherein the object description includes one or more selected from the group consisting of: object reference, object key, reference counter and time stamp.

14. A software engine as claimed in claim 10, wherein the de-allocation of one or more of the objects includes an arbitrary time offset.

15. A software engine as claimed in claim 14, wherein if the object description of an object in the object repository has a reference counter equal to zero for a time equal to at least the time offset, the corresponding object description is removed from the object repository.

16. A software engine as claimed in claim 1, wherein the loading is downloading over the Internet.

17. A method of loading a software application onto a user's machine using a software engine, the method including loading onto the user's machine core services of the application to enable the user to interact with the application, and loading non-core services of the application according to a priority order determined by the engine.

18. A method as claimed in claim 17, wherein the engine is part of the core service and is loaded with the core service.

19. A method as claimed in claim 18, wherein the engine commences operation upon completion of loading of the core service.

20. A method as claimed in claim 17, wherein before loading the non-core services they are registered with the engine.

21. A method as claimed in claim 17, wherein with the priority order there is created a top priority, top priority being given to any non-core services of the application required to be on the user's machine as a result of interaction with the application by the user.

22. A method as claimed 21, wherein upon interaction with the application by the user, the application requests the engine to load at least one of the non-core services, the engine checks the registration and gives the at least one non-core service top priority for loading.

23. A method as claimed in claim 21, wherein the loading of the non-core services is in a manner controlled by the engine.

24. A method as claimed in claim 23, wherein the control takes into account user interaction with the application.

25. A method as claimed in claim 17, wherein objects of the application are storable in a cache for reuse.

26. A method as claimed in claim 25, wherein cached objects are tracked using a memory management module of the engine, which can de-allocate one or more of the objects.

27. A method as claimed in claim 26, wherein the cache is operative only when the application is on the user's machine.

28. A method as claimed in claim 25, wherein the objects are placed into an object repository in the cache, together with an object description.

29. A method as claimed in claim 28, wherein the object description includes one or more selected from the group consisting of: object reference, object key, reference counter and time stamp.

30. A method as claimed in claim 26, wherein de-allocation includes an arbitrary time offset.

31. A method as claimed in claim 30, wherein if the object description of an object repository has a reference counter to equal to zero for a time equal to at least the time offset, the corresponding object description is removed from the object repository.

32. A method as claimed in claim 17, wherein the loading in downloading over the Internet.

33. A computer memory management system for use with a software application, the memory management system including a cache, and wherein objects of the application are storable in the cache for reuse.

34. A system as claimed in claim 33, wherein the cache is operative only when the application is on the user's machine.

35. A system as claimed in claim 33, wherein the objects are placed into an object repository in the cache, together with an object description.

36. A system as claimed in claim 35, wherein the object description includes one or more selected from the group consisting of: object reference, object key, reference counter and time stamp.

37. A system as claimed in claim 33, wherein cached objects are tracked using a memory management module, which can de-allocate one or more of the objects.

38. A system as claimed in claim 37, wherein de-allocation includes an arbitrary time offset.

39. A system as claimed in claim 38, wherein if the object description of an object repository has a reference counter to equal to zero for a time equal to at least the time offset, the corresponding object description is removed from the object repository.
